(19) United States
(12) Patent Application Publication
(10) Pub. No.: US 2001/0050821 A1
(43) Pub. Date: Dec. 13, 2001

(54) System for geometric beam shaping of a light beam profile

(76) Inventors: Gunter Bickleder, Aldorf (DE); Arno Euteneuer, Germering (DE); Harald Rossmeier, Munchen (DE); Thomas Weber, Ottobrunn (DE)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/832,018

(22) Filed: Apr. 11, 2001

(30) Foreign Application Priority Data
Apr. 11, 2000 (DE) 100 17 884.7

(51) Int. Cl. G02B 26/08; G02B 5/04; G02B 7/18

(52) U.S. Cl. 359/837; 359/211; 359/831

(57) ABSTRACT

What is described here is a system for as well as a method of geometric beam shaping of the beam profile of a light beam, comprising a first prism and a second prism optically transparent to the light beam, which prisms are so disposed in the optical path of he light beam in such a way that after the passage of the light beam through both prisms the beam profile of the light beam may be expanded or reduced in a direction orthogonal on its direction of propagation by a first factor, and by a second factor different from the first factor in a direction orthogonal on the first direction.

The invention excels itself by the provision that the first prism is supported for rotation about an axis of rotation and that the second prism is rotatable about a further axis of rotation and is supported for movement along a curve relative to the first prism.

### FIELD OF THE INVENTION

The present invention relates to a system for as well as a method of geometric beam shaping of the beam profile of a light beam, comprising a first prism and a second prism optically transparent to the light beam, which prisms are disposed in the optical path of said light beam in such a way that after the passage of said light beam through both prisms the beam profile of said light beam may be expanded or reduced in a direction orthogonal on its direction of propagation by a first factor, and by a second factor different from said first factor in a direction orthogonal on said first direction.

### PRIOR ART

A system of the afore-defined general type is used, for instance, for shaping the beam profile of the elliptic beam profile of semiconductor lasers emitting on the edges for conversion into a round beam profile. There are two different methods available to this end on principle:

(a) the application of a cylinder lens anamorphic expander consisting of two cylinder lenses disposed like a telescope, and

(b) a prism anamorphic expander consisting of one or several glass prisms, that corresponds to the aforedescribed system.

The disadvantage entailed by the application of a cylinder lens anamorphic expander consists in the anamorphotic expansion that is invariably defined by the to focal lengths of the lenses. The advantage of a prism anamorphic expander resides in the possibility to vary the expansion by a change of the angle of incidence of the prisms. Wave front characteristics—such as astigmatism—by contrast are not influenced.

For influencing the beam profile of light beams by means of optical units the following facts apply on principle:

Light beams entering through a planar boundary surface from an optically thin into an optically dense medium are always refracted “towards the vertical”, which is linked up with an anamorphotic expansion, i.e. an expansion only along a preferred axis in space that causes hence a distortion of the beam profile, as soon as a variation occurs from the orthogonal incidence of light onto the boundary surface.

Upon exit from the optically denser into the optically thinner medium, by contrast, refraction occurs “away from the vertical”, which is always linked up with an anamorphotic “reduction”. In both cases an expansion/reduction of 1 is achieved for an orthogonal incidence. When now an anamorphotic expansion is to be achieved selectively by means of a prism it is merely necessary to ensure that the expansion at entry into the prism will not be overcompensated by the reduction at exit therefrom. It is easily possible in this case to adjust the overall expansion over a wide range—from reduction to expansion—by varying the angle of incidence.

As after passage of a light beam through a prism the beam is deflected by a defined angle from its original direction of orientation often a second prism is used to restore the original beam direction again. To this end the second prism is rotated through 180° relative to the first prism so that the angle of incidence into the second prism equals the angle of incidence into the first prism in order to deflect the light beam by the same angle into the opposite direction. The overall expansion of the pair of prisms is the product of the individual expansions, which means the square of the expansion of an individual prism in the case of a symmetrical arrangement.

### BRIEF DESCRIPTION OF THE INVENTION

The present invention is based on the problem of improving a system for and a method of geometric beam shaping of the beam profile of a light beam, using a first prism and a second prism optically transparent to the light beam, which prisms are disposed in the optical path of the light beam in such a way that after the passage of the light beam through both prisms the beam profile of the light beam may be expanded or reduced in a direction orthogonal on its direction of propagation by a first factor, and by a second factor different from the first factor in a direction orthogonal on said first direction, this improvement being made in such a way that easy operability will be ensured and that the handling and introduction of the system into the optical path of an optical system will be possible. In particular, the anamorphotic system should permit an expansion or reduction of the beam profile without a variation of the beam position of the light beam. The easy operability of the system, which should be moreover designed with a compact structure requiring little adjustment, is deemed to constitute a special aspect.

The solution to the problem underlying the present invention is defined in claim 1 as well as in claim 7. Features constituting expedient improvements of the inventive idea are defined in the dependent claims.

In accordance with the present invention a system according to the introductory clause of claim 1 is improved in a manner that the first prism is supported for rotation about an axis of rotation ands that the second prism is rotatable about another axis of rotation and supported for movement along a curve relative to the first prism.

The anamorphotic expansion of the pair of prisms is defined by the respective angles of incidence at which the light beam is incident on the surfaces of incidence of the prisms. When hence a beam direction and an expansion are predetermined and it is moreover intended that the output beam extends in parallel with the incident beam the angles at which the two prisms must be disposed relative to each other and relative to the beam are unambiguously determined. The only free parameter is the parallel offset between the input beam and the output beam. This offset is determined by the distance between the two prisms.

With the size of the prisms a certain minimum beam offset is predetermined. Each beam offset can be generated, on principle, by different positions of the second prism, however it is sensible to position the prism in such a way that the beam hits the entrance surface thereof at a central point so as to avoid a unilateral cut-off of beams having larger diameters at the edge of the prism. When now the same beam offset should be achieved for all expansions and when it is intended to hit the entrance surface of the second prism at a central point a position of the second prism relative to the first one is unambiguously predetermined for each expansion.

Such an anamorphic expander with a variable expansion factor, which furnishes additionally an invariably equal beam offset, is expedient for many applications. Such an anamorphic expander can be realised in the form of a pair of anamorphotic prisms on the condition that a mount for the two prisms offers the following degrees of freedom:

(1) both prisms are rotatable each about one axis (parallel with both entrance surfaces),

(2) the second prism is displaceable relative to the first prism in such a way that the respectively desired beam offset is adjustable or constant, respectively.

With the relative spacing between both prisms only playing a role, the first prism may be mounted for rotation at an invariable location. The axis of rotation is sensibly passed through the centre of the entrance surface, which the input light beam should hit, too. The second prism is rotatable and mounted for displacement.

When the demands on the anamorphic expander are reduced to a single constant parallel offset between the input and output beams the second prism must be displaceable only along a line resulting from the family of positions which the prism must assume for the various expansion factors in order to achieve the predetermined beam offset. The line is sensible derived from the conditions

(a) that one should be able to adjust the beam offset, and

(b) that the second prism should be hit centrally on its entrance surface.

In the calculation of such a line one will find that the curve so obtained can be very well approximated by a straight line inclined by a few degrees relative to the incident beam. As a rule, it is sufficient to displace the second prism along this straight line.

The arrangement of the two prisms of such a prism anamorphic expander is realised in such a way that

(a) the first prism is supported for rotation about an axis of rotation stationary in the mount, which axis passes through the centre of the entrance surface of the first prism,

(b) the second prism is rotatable about an axis of rotation passing through the centre of its entrance surface, and

(c) that the second prism is displaceable With its axis of rotation along a defined straight line or a defined curve.

### BRIEF DESCRIPTION OF THE INVENTION

The invention will be described in the following by exemplary embodiments, with reference to the drawing, without any restriction of the general inventive idea. In the drawing:

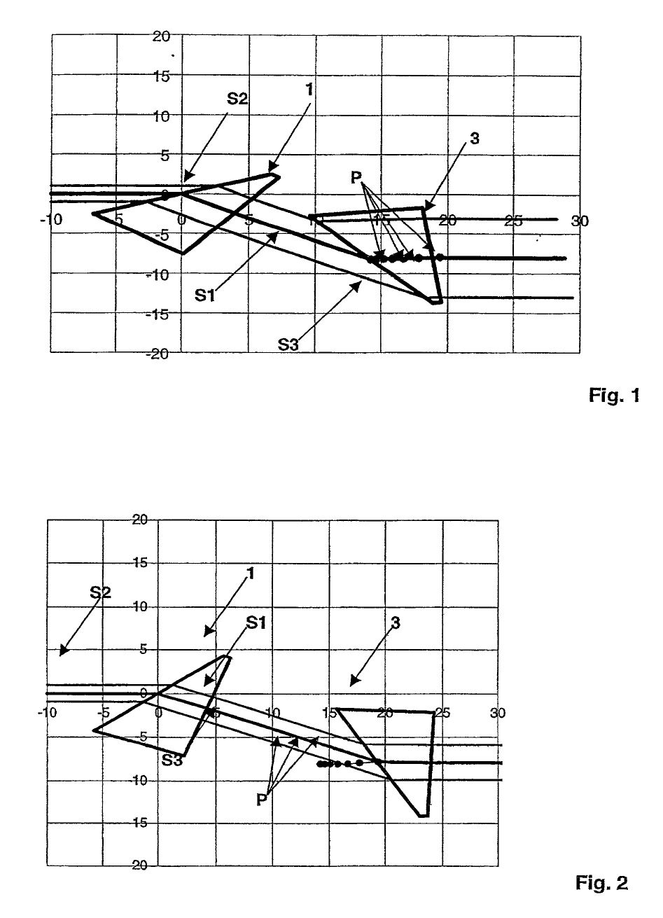

FIG. 1 shows the beam path through the prism system with quintuple expansion of the beam profile,

FIG. 2 illustrates the beam path through the prism system with double expansion of the beam profile, and

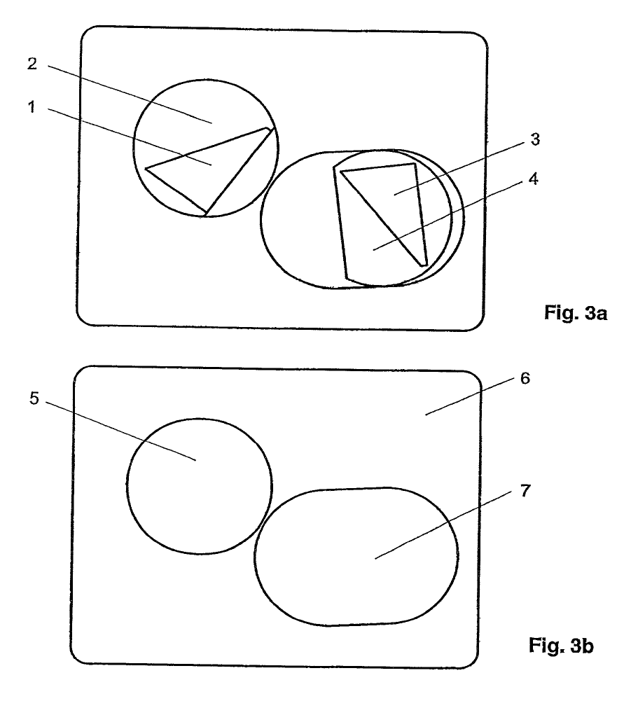

FIGS. 3a, b show an embodiment of the prism system.

### WAYS OF REALIZING THE INVENTION, INDUSTRIAL APPLICABILITY

FIG. 1 illustrates a prism system including the prisms 1 and 3 through which a pencil of light beams S1, S2, S3 passes, whereof the light beam S1 passes centrally through the prism system. The prism 1 is disposed and supported for rotation at the zero point of the coordinates. The second prism 3 is equally supported for rotation about an axis of rotation that is defined by the intersection of the light beam S1 with the entrance surface of the prism 3. Moreover, the second prism 3 is mobile along the points P. In the system according to FIG. 1, the prisms expand the light beam S1-S3 by a factor of 5 in one direction whereas the system of the prisms shown in FIG. 2 expand the light beam S1-S3 merely by the factor of 2. What is essential, however, is the fact that after the passage through the prism system the beam position of the light beam S1 is identical in both cases (cf. S1 at −8 approximately along the ordinate).

FIGS. 3a, b illustrate a conceivable embodiment according to which the prisms 1 and 3 can be mechanically mounted relative to each other.

The first prism 1 is fastened on a round disk 2 such that the centre straight line of the entrance side is located on the centre of the disk 2. For a facilitated assembly the disk 2 may be milled in such a way that the edge of the exit side of the prism will coincide with the edge of the disk.

The second prism 3 is fastened on a round disk 4 of the same size so that the centre straight line of the entrance side will be located on the centre of the disk 4.

The two disks provided with prisms are inserted into a carrier plate 6 presenting a round countersunk section 5 of the size of the disk 2 and an elongate countersunk section 7. The centre of the round countersunk section 5 and the centre line of the elongate countersunk section 7 are located relative to each other in such a way that the aforedescribed function will be ensured.

In a further-going embodiment—that is not shown here in details—the basic bodies 2 and 4, on which the prisms 1 and 3 are mounted, are so designed and connected to each other—for instance via round or eccentric tooth lock washers—that when the expansion is varied merely by rotation on prism 1 the second prism follows this rotation in such a way that the overall expansion is uniformly distributed over the first and second prism, while the second prism is moved along the distance in such a way that the beam position remains constant.

The inventive system is linked up with the following advantages:

(a) The system may be mounted in a housing having an entrance and exit diaphragm in such a way that the beam position and the beam direction of the input beam and the output beam remain constant on the entrance or exit diaphragm and that only the beam cross-section is varied when the prisms are adjusted. Such an adjusting unit may be simply integrated into invariable optical paths.

(b) Due to the rotatability of the prisms a defined expansion ratio can be successfully adjusted even for various wavelengths subjected to refraction in different intensities in the prisms as a result of the dispersion curve. As a result, the system is useful over a wide range of wavelengths. Restrictions merely occur in the event of additional antireflection coatings on the prism surfaces.

(c) When the first prism is rotated the input beam remains always in the centre of the entrance surface of the prism and can therefore occupy the entire entrance surface.

(d) Laser diodes present frequently wide tolerances in the emission (divergence) angle. In the event of stationary mounting of the prisms this would result in the situation that the cross-section of the output beam of the anamorphic expander is not always precisely circular. The rotatability of the prisms permits a consideration of the divergence angle of the individual laser diodes in the expansion and the achievement of a circular beam profile in all cases.

(e) The pair of prisms can be calculated for minimum losses in reflection. In the case of an average expansion a polarised beam will then be incident at the Brewster angle and is not exposed to losses due to reflection. When the expansion is varied the angles remain in the vicinity of the Brewster angle while the losses in reflection remain at a low level.

(f) When the second prism is rotated the input beam always remains in the centre of the entrance surface of the second prism and can therefore occupy the entire entrance surface.

(g) The pivot of the second prism can be displaced along a distance in such a manner that in the case of a variation of the expansion factor, i.e. rotation of the first and/or the second prism, the beam offset is always maintained.

(h) The prisms are guided in a form that the user is able to vary only those degrees of freedom which are required for adjustment.

(i) With an appropriate mechanical design the degrees of freedom of the prisms can be so restricted that the user can rotate the first prism only while he can rotate the second prism and shift it along the previously calculated distance.

(j) With an appropriate mechanical design the two prisms can be connected, e.g. by means of gear wheels, that when the expansion factor is varied merely by rotation of the first prism the second prism will not follow this rotating movement so that the overall expansion is uniformly distributed to both prisms, while the second prism is moved along the distance in such a way that the beam position remains constant.

1. System for geometric beam shaping of the beam profile of a light beam, comprising a first prism and a second prism optically transparent to the light beam, which prisms are disposed in the optical path of said light beam in such a way that after the passage of said light beam through both prisms the beam profile of said light beam may be expanded or reduced in a direction orthogonal on its direction of propagation by a first factor, and by a second factor different from said first factor in a direction orthogonal on said first direction, characterised in that said first prism is supported for rotation about an axis of rotation and that said second prism is rotatable about a further axis of rotation and is supported for movement along a curve relative to said first prism.

2. System according to claim 1,
characterised in that said first prism and said second prism present each an entrance surface and an exit surface through which said light beam enters or leaves the prism, that both said one axis of rotation and said other axis of rotation, about which said first prism or said second prism, respectively, is supported for rotation, extend centrally in the entrance surface of the respective prism, and
that said second prism is mobile with its axis of rotation along said curve.

3. System according to claim 1 or 2,
characterised in that said curve is approximated as a straight line.

4. System according to claim 3,
characterised in that said straight line along which said axis of rotation of said second prism is mobile is inclined relative to the beam direction of said light beam immediately ahead of the entry into said entrance surface of said first prism.

5. System according to any of the claims 1 to 4,
characterised in that said first prism and said second prism are disposed relative to each other in such a way that a light beam centrally passing through said first prism will be centrally incident on the entrance surface of said second prism.

6. System according to any of the claims 1 to 5,
characterised in that said first prism and said second prism are cinematically connected to each other in such a manner that when said first prism is rotated said second prism is selectively rotated and shifted.

7. Method of geometric beam shaping of the beam profile of a light beam, using a system according to any of the claims 1 to 6,
characterised in that an expansion or reduction of the beam profile after exit from said second prism is obtained by rotating said first prism and by rotating and shifting said second prism.

8. Method according to claim 7,
characterised in that the rotation of said first prism and the rotation of said second prism as well as the shift of said second prism are mutually tuned in such a way that the beam offset to which the light beam is subjected after passage through both prisms remains unvaried.
